(19) United States
(12) Patent Application Publication
(10) Pub. No.: US 2010/0077002 A1
(43) Pub. Date: Mar. 25, 2010

(54) DIRECT ACCESS METHOD TO MEDIA INFORMATION

(76) Inventors: Knud Funch, Thisted (DK); Sam de Jongh Hepworth, Struer (DK)

Correspondence Address: HARNESS, DICKEY & PIERCE, P.L.C., P.O. BOX 8910, RESTON, VA, 20195, US

(21) Appl. No.: 12/448,014

(22) PCT Filed: Apr. 4, 2007
(86) PCT No.: PCT/DK2007/000176

§ 371 Date: Jun. 4, 2009

(30) Foreign Application Priority Data
Dec. 6, 2006 (DK) PA 2006 01607

(51) Int. Cl. G06F 17/30

(52) U.S. Cl. 707/779; 707/E17.101; 707/E17.019; 707/E17.014

(57) ABSTRACT

An event provider, such as a media player, and a method of operating the media player in which the events stored therein or available thereto are divided/filtered into groups, where all groups comprising all of the events, and where, when a group of events is provided is offered for the user in a non hierarchical mode of operation. Media players with improved user interfaces are illustrated.

The present invention relates to a method of operating a media player and in particular a method of instructing the media player to present events in a direct mode of access. The events normally are media information, audio, images or video, such as music tracks, pictures, or movies. The media player may be a dedicated media player, such as a standard MP3 player, or may form part of another type of equipment, such as a cell phone, a bookreader (eBook), a stereo, or a PC.

Normally, selecting the information that the media player should provide is managed by a top down scroll through the folders and/or tracks stored thereon (or at least available thereto). It might be a very cumbersome manual process to traverse up/down in the hierarchical menu structures containing the target media information, e.g. media files, to be presented for the user.

The aim of the invention is to provide media Information in an improved manner.

In a first aspect, the invention relates to a method of operating an event provider, the method comprising:
providing a plurality of events or groups of events adapted to be provided on the event provider, each event/group having a number of parameters assigned thereto or derivable there from,
selecting, using a first search criterion, a first group of the plurality of events/groups falling within the first search criterion,
selecting, using a second search criterion, a second group of events/groups from the first group of events/groups falling within the second search criterion,
providing a list of events/groups to be provided on the event provider, the list comprising the events/groups of the second group of events/groups and the remaining events/groups of the first group of events/groups in a predetermined order.

In the present context, an event may be audio, video, pictures, graphics/text in any mix thereof, and may be stored in or on the player or be available thereto via e.g. a network, like links or data including podcasts, or via external storage units.

A group of events may comprise one or more events. Normally events of a group will have one or more parameters in common, such as an author/artist/genre, or the like.

Parameters may be provided with the event/group from external sources, such as the adding of artist or composer, or may be derivable there from, such as by analysis of the event/group (beats-per-minute, genre, duration, etc.). In addition or alternatively, the user may him/herself provide parameters to the events or identify events to belong to a given group. Naturally, an event may be a member of any number of groups. Also, any number of parameters may be used for filtering (title, author and genre, etc.).

In the present context, a parameter may be any piece of Information describing the event or something connected thereto. Different standards exist for different types of events, such as the ID3.v2 standard for audio files and EXIF for video. Such parameters may be: author, artist, group, name, title, producer, date/year of production/issuance/birth, genre, theme, pace/beats-per-minute, played recently/never, most/never/recently used, oldies, or the like. In addition, a parameter may be a type of file in which the event is stored (tiff, mpeg, mp3, etc.).

In the present context, the event provider may be any type of media player, such as a stand-alone media player, such as a standard MP3-player, or it may form part of equipment also having other functions, such as a cell phone, a PDA, an eBook, a PC, an AV system or the like.

According to the invention, a first search may be made on the basis of a search criterion, such as on the basis of one or more parameters, and the second search may be made in the results of the first search. However, the results of the first search are all introduced into the list. The second search may be used for “ordering” the results of the first search.

Naturally, the search criteria may be any combination of the parameters or parts of the parameters (such as all authors beginning with an “a” combined with the genre “pop music”).

Preferably, the predetermined order is that the events/groups of the second group of events/groups are provided before the remaining events/groups of the first group of events/groups.

Naturally, the list may be used for forwarding to a media player or be stored for future use as a play list. In general, however, preferably, the method further comprises the step of the event provider sequentially providing the events/groups in the order of the list.

Thus, even though several searches may be performed in order to Identify and have provided the events/groups desired, more events/groups than those fulfilling the narrowest search criterion is put on the list.

In a second aspect, the Invention relates to an event provider for providing, to a user, events or groups of events from a list of events/groups, the provider comprising:
means for holding or accessing a plurality of events/groups adapted to be provided on the event provider, each event having a number of parameters assigned thereto or derivable there from,
means for providing one or more events/groups to the user,
means for allowing the user to select, using a first search criterion, a first group of the plurality of events/groups falling within the first search criterion,
means for allowing the user to select, using a second search criterion, a second group of the first group of events/groups falling within the second search criterion,
means for controlling the providing means to provide the events/groups of the second group of events/groups and the remaining events/groups of the first group of events/groups in a predetermined order.

Naturally, the allowing means may be any type of means allowing the user to interact with the provider, such as keyboards, buttons, touch pads, rotating wheels, rocking contacts, voice recognition, image recognition, or the like.

The providing means will depend on the type of events/groups but may comprise a display and/or speakers adapted to visually and/or audibly provide the event/group to the user.

The selection of a search criterion may be an interaction between illustrating possible search criteria on a display and using e.g. a keyboard in order to select one, or the criterion or Information identifying the criterion, may be entered directly via e.g. a keyboard, touch pad, rotating wheel, voice recognition or any other usual manner of interacting with hand held devices, computers or the like.

In one embodiment, the controlling means is adapted to provide, to the providing means, the events/groups of the second group before the remaining events/groups of the first group of events/groups.

Preferably, as is described above, the provider is adapted to provide, sequentially, the events/groups in the order of the list.

Naturally, the controlling means may be any type of controller, such as a PC, a microchip, a microcontroller, an ASIC, hardwired electronics, an FPGA, or the like, normally controlled by controlling instructions stored in a RAM, ROM, PROM, EPROM, EEPROM, Flash, tape, disc, card, electrical, magnetic, or optical, or the like. The means for holding or storing the events/groups may be chosen from the same group.

A third aspect relates to a method of selecting an event or a group of events to be provided on an event provider, the method comprising:
defining on a user interface, a first axis,
assigning, to each event or group of events, a position on the first axis, the position of each event or group of events being different from the position of all other events or groups of events, each event or group of events having a number of parameters assigned thereto or derivable there from,
a user identifying or selecting a position on the first axis,
information being provided, on a display, relating to the event or group of events assigned to the selected or identified position.

In the present context, the definition of events, groups of events, providing of events, means for providing events etc as provided above are equally useful.

A user interface, in this context, is any type of interface with which a user may interact with the system. The user interface comprises a display and, as is also described further above, means for the user to enter instructions, such as search criteria or, as in the present aspect, information allowing the system to derive a position along an axis defined on the user interface.

Naturally, this axis may be defined in any manner, and it may be straight, circular, oval, square, triangular, or any other desired shape. It may be a closed curve or not. Normally, the axis will be confined to a single plane, but this is in no way a limitation to the aspect to the Invention but merely suitable for use in the user interfaces used today.

The user interface comprises a display which may or may not be used in the definition of the axis. In certain embodiments, the axis may be defined as an axis on the display, and in other embodiments, the axis is defined independently of the display.

According to this aspect, the events or groups of events are assigned a position along the axis, whereby moving the position along the axis may bring about a providing, on the display, information relating to a number of sequentially positioned events/groups.

The position assigned each event/group may be assigned according to any strategy, such as in accordance with an order according to one or more of the parameters of the event/group. The positions may be relative, so that the number of events/groups are distributed, along any order, along the axis and between two extremes. The adding of further events/groups may then redefine the positions, whereas the relative positions of most events/groups may be maintained.

Preferably, the selecting/identifying step comprises sequentially identifying positions or selecting a scrolling/moving position along the first axis, and wherein the Information providing step comprises providing information relating to a sequence of events or groups of events. This Information may be provided at the same position on the display for all events/groups or may be provided at different positions for different events/groups, such as at positions on the display (or of the display) related to the positions of the events/groups on the axis.

In general, the Information providing step may comprise providing no or a first predetermined amount of information relating to each event or group of events at positions not identified/selected and providing additional information relating to event(s) or group(s) of events at the selected/identified position. Thus, the event/group assigned to the actual position will have more information provided.

Numerous manners of providing information on a display may be used. Firstly, no information or only a little information (one or more predetermined pieces of information, such as parameter(s)) may be provided for one, more or all events/groups not assigned to the relevant position. No Information is no information at all, but little information may be as little as only an indication, that an event/group is present at the position (e.g. just a vertical line), or the back of e.g. a CD, record, book, DVD, VCR cassette, or the like, may be simulated such that e.g. the title, the author, the genre, or the like of the event/group may be determinable.

The event/group at the actual position may then have more information provided, such as the front of the CD/record/book/DVD/cassette, or other Information may be provided. The transition of the Information provided (if any) when the position of the event/group is not selected/identified to the information provided when the position thereof is identified/selected may be chosen in any manner desirable. This transition may be provided, when the position selected (if a position is constantly selected and approaching the position of the event), as a function of how close the identified position is to that of the event (the transition may then depend on how fast the position identified approaches that of the event). Alternatively, the transition is a predetermined transition not performed before the position of the event/group has been reached/identified.

In one embodiment, the display will emulate the CD/record, etc. being rotated from the position at which just the back thereof is illustrated to the position where the front is illustrated. In another embodiment, no information is provided for events/groups not at the position, but the information provided at the position is an image representing the group/event, such as the front of a cover of a CD/DVD, etc, of the event/group.

Naturally, it may be desired or possible to identify positions between those assigned to the groups/events. In that position, a position identified between those of two events/groups may be handled differently. In one embodiment, no Information is provided related to any of the neighbouring events/groups, and in another embodiment, information, such as all of or part of the information, may be provided related to the two neighbouring groups/events. An example of the latter being an emulation of the fronts of all CD's/DVD's, etc, positioned adjacently, where either the full fronts of both groups/events are provided on the display, or neighbouring parts thereof is illustrated.

In one embodiment, the step of assigning each event or group of events to a position comprises assigning the events or groups of events along the axis according to a predetermined order in relation to one or more first parameters.

In that situation, the method may further comprise the steps of:
defining on the user interface, a second axis,
assigning, to each event or group of events, a position on the axis, the position of each event or group of events being different from the position of all other events or groups of events, the position on the second axis of the events or groups of events being according to a predetermined order in relation to one or more second parameters different from the first parameter(s),
a user identifying or selecting a position on the second axis,
information being provided on a display relating to the event or group of events assigned to the selected or identified position on the second axis.

In this manner, different strategies of e.g. sorting the events/groups may be selected between, which may adapt the system or method to different persons or tastes, or may actually facilitate searching in the groups/events. One example is that in which a group or event is identified (or the position thereof is) on the first axis, and where a search relating to a parameter of this identified event/group is desired, changing to the second axis, which could then be ordered along that parameter, would render the neighbouring events/groups, along the second axis, the desired results of that search.

In one particular embodiment, the user interface comprises the display and an arrangement along which the display may be translated or displaced along the first axis, and the step of the user identifying or selecting the position on the first axis comprises the user causing a displacement of the display to the position along the first axis.

In this situation, shifting between the two axes may actually have the display automatically move to the position, on the other axis, of the presently identified event/group at which the display was when shifting to the other axis.

In this embodiment, translating the display along the arrangement will bring the display past a number of positions of events/groups, the information of which may then be provided sequentially during this translation. This may be a simple and desirable manner for e.g. searching for a particular event or group of events.

Also, it may be desired that the second and first axes are parallel and that the step of the user identifying or selecting the position on the second axis then comprises the user firstly causing a displacement of the display in a direction at an angle to the first axis, so as to e.g. indicate the change from the first axis to the second axis, and subsequently causes a displacement of the display to the position along the second axis. In this manner, the same display and arrangement may be used for displaying the events/groups in different manner while remaining simple.

In another embodiment, the user interface comprises the display over the surface of which at least a part of the axis or axes is/are Identified. Then, the display may be a touch sensitive display, whereby the user may select or identify the position simply by touching the display. Alternatively, buttons, a computer mouse, or the like may be used for identifying the position.

Yet another embodiment is one where a physical element, which need not be a display, may be translated in relation to the display, and where the display then provides the Information pertaining to the position of the element. This element may have any shape desirable, such as one emulating a lens. The display may provide, at the position of the element, the Information of the event/group assigned the relevant position. This is much like the above embodiment with the sliding display, including the providing of the second axis.

In general, the method may comprise detaching the display from remaining parts of the user interface and subsequently attaching the display to the other parts of the user interface. Thus, the display, and optionally also means allowing the user to indicate/select the position (buttons, touch pads, wheels as described above), may be removable from the remaining parts, which may be stationary, such as wall mounted.

Also, in general, the method may comprise displaying, as at least part of the information provided on the display, one or more alternatives which the user may choose between, the method further comprising carrying out operations relating to the choice made by the user. Thus, having identified a position of a desired event/group of events, the user may be presented with the option to have the event provided, such as the playing of an audio track, the showing of a movie, the illustration of a picture or a page of a book, or the like. Alternatively or additionally, the user may choose to forward the event/group to another event provider, a storage medium (portable or not), or the addition of the event/group to a playlist for future use.

In a fourth aspect, the invention relates to an apparatus for use by a user to select an event or a group of events to be provided on an event provider, the apparatus comprising:
a user interface defining a first axis,
means for assigning, to each event or group of events, a position on the first axis, the position of each event or group of events being different from the position of all other events or groups of events, each event or group of events having a number of parameters assigned thereto or derivable there from,
first means for allowing a user to identify or select a position on the first axis,
a display,
means for controlling the display to provide information relating to the event or group of events assigned to the selected or identified position.

Then, the allowing means could be adapted to allow the user to sequentially Identify positions or selecting a scrolling position along the first axis, and wherein the controlling means are adapted to control the display to display scrolling information relating to a sequence of events or groups of events.

Also, the controlling means could be adapted to provide no or a first predetermined amount of information relating to one, more or all events or groups of events, on the display, at positions not identified/selected and to provide additional information relating to event(s) or group(s) of events at the selected/identified position.

In addition, the assigning means preferably are adapted to assign the events or groups of events along the axis according to a predetermined order in relation to one or more first parameters.

Then, the user interface preferably additionally defines a second axis, the apparatus further comprising:
means for assigning, to each event or group of events, a position on the second axis, the position of each event or group of events being different from the position of all other events or groups of events, the position on the second axis of the events or groups of events being according to a predetermined order in relation to one or more second parameters different from the first parameter(s),
second means allowing a user to identify or select a position on the second axis,
   the controlling means being adapted to control the display to provide information relating to the event or group of events assigned to the selected or identified position on the second axis.

In general, the user interface preferably comprises the display and an arrangement along which the display may be translated or displaced along the first axis, wherein the first allowing means are adapted to determine a position Identified or selected by the user. This may either be due to the user positioning the display at that situation, or the apparatus may comprise means for translating or displacing the display to the identified or selected position on the first axis. As mentioned above, the allowing means may be any means used for entering Information into computers, handheld devices, PDA's, or the like.

Naturally, the allowing means may be used for scrolling by providing or identifying sequential positions along the axis, where the information relating to the events/groups, the positions are “visited” may be provided sequentially as a scrolling of information.

Also, the first and second axes may be at least substantially parallel, and the second allowing means may be adapted to allow the user to identify or select the position on the second axis by firstly causing a displacement of the display in a direction at an angle to the first axis and subsequently causes a displacement of the display to the position along the second axis.

Then, when the display is positioned at a position on the first axis, and the user wishes to use the second axis, the display may automatically move to the position on the second axis of the event/group, the position of which the display was when instructed to change to the second axis.

As mentioned above, an alternative would be a user interface being a display over which (over the surface) the axis/axes is/are defined. Then, the position may be selectable when the display is a touch screen, using a computer mouse, buttons or the like, or using an element displaceable in relation to the display, where the position of the element in relation to the display will define the position, and where the display may, e.g., display the pertaining Information at the position of the element.

In general, it may be desirable that the display, and optionally also means for allowing the user to identify the position, is/are detachably attached to remaining parts of the user interface. In this situation, the apparatus may be remote controlled.

As mentioned above, the controlling means may be adapted to control the display to display, as at least part of the information provided on the display, one or more alternatives which the user may choose between, the apparatus further comprising means for determining a choice of the user and means for carrying out operations relating to the choice made by the user.

A fifth aspect of the invention relates to a method of manoeuvring in a group of pieces of Information, the method comprising:
providing, on a display, at least a part of one or more pieces of information, the information being ordered in a predetermined order,
a user manipulating a user interface to indicate a direction in the predetermined order and a speed of scrolling along the indicated direction,
scrolling through the information along the predetermined direction and the indicated speed while, for each piece of Information provided on the display during scrolling, providing an amount of the information depending on the indicated speed.

This aspect of the invention relates to fast manoeuvring in pieces of information, where it has been realized that when Information is changing swiftly, the human eye is not adapted to analyze a large amount of Information distributed over a large area.

Consequently, the amount of information provided from each piece of information depends, according to this aspect of the invention, on the speed of the scrolling or exchanging of the information.

In this context, the pieces of information may be visible information, such as images, or parts thereof, or text. If images are scrolled, only parts thereof may be provided, such as smaller areas thereof, when the scrolling speed is so high that not all of the image is to be provided. If the pieces of information are texts, only a part of the text may then be provided.

Also, in this context, any order may be used. An ordering of the pieces of information is especially desirable when only part thereof is provided. This renders searching faster.

Scrolling of information is a well-known task, wherein information is provided at different positions over the display, usually along a straight line, but also other positions or curves are useful, see below. Normally, not all the pieces of information will be provided on the display at the same time, whereby scrolling is a suitable manner of providing the information desired.

It should be noted that “scrolling” in the present context, is not limited to any particular manner or position of providing of the individual parts of the pieces of information.

In this respect, the speed of the scrolling merely indicates how swiftly a piece of information moves over the display, how shortly it remains in the same position, for how long it is overall provided on the display, or any other suitable manner of determining or measuring the replacement frequency of the pieces of information on the display.

Naturally, the determination, from the relation between the fraction of the individual piece of information to be provided on the display and the speed of the scrolling, may be made dependent on the nature of the display, the user, and the particular pieces of information. Users are much better suited at recognizing simple images than complicated patterns, whereby a smaller part of a simple image may be provided while being recognizable compared to more complex patterns which may require a larger portion provided.

When the pieces of information are texts, the ordering may be alphabetical, and the parts provided may be the first letters/characters. The number of letters/characters provided may then be made dependent on the indicated speed. Scrolling swiftly, only one or a few of characters may be provided for each piece of information, whereas more characters may be provided at lower speeds.

For manoeuvring in texts which are e.g. titles, artists, or the like, an alphabetical ordering is suitable, and the scrolling speed will be high, until the desired initial characters are reached, whereas a lower speed will provide additional characters and a more precise navigation.

In one embodiment, the manipulation step comprises the user operating a wheel or a circular touch pad, the direction of rotation of the wheel indicating the direction of navigation in the order, and the velocity of rotation of the wheel or touch indicating the speed.

Alternatively, other means may be used for the user to indicate direction and speed, such as hard/soft or short/prolonged touch on a touch pad (combined with a direction), providing different buttons for direction and different speeds, using a computer mouse, or the like.

Naturally, the pieces of Information may relate to events or groups of events, and the method may be used for selecting an event/group, which the user may then (or merely by the selection) have provided using an event provider as mentioned further above. Then, the pieces of information provided may be texts or images relating to the events/groups, such as artists, titles or other parameters as described further above.

In a sixth aspect, the invention relates to an apparatus for navigating in a group of pieces of information, the apparatus comprising:
a display for providing information,
means for controlling the display to provide at least part of one or more pieces of information ordered according to a predetermined order,
means for a user to manipulate to indicate a direction and speed of scrolling of the information,
   the controlling means being adapted to scroll the information in the direction indicated and have the display provide, for each piece of Information provided on the display, a part thereof depending on the speed indicated.

In one embodiment, the pieces of Information are text, and wherein the controlling means are adapted to provide, as the parts, a number of characters of the texts, depending on the speed indicated.

In a particularly interesting embodiment, the manipulating means comprise a rotatable wheel or a round touch pad, and wherein the controlling means are adapted to derive the direction of scrolling from a direction of rotation/touch of the wheel/pad, and the speed from a rotational velocity/touch of the wheel/pad.

In a seventh aspect, the invention relates to a method of providing events to be provided to a user on an event provider, the method comprising:
providing a plurality of groups of events, each group of events comprising a number of events and having, common to all events thereof, one or more first parameters, each event having one or more second parameters,
providing, on a display and in a predetermined order, one or more of the first parameters of a plurality of groups of events,
receiving an input from the user,
subsequently providing, on the display, one or more of the second parameters of one or more events of at least two groups of events positioned adjacently in the predetermined order.

As is mentioned above, the parameter(s) of an event or group may be assigned thereto, derivable there from or provided in any other manner.

The input from the user may be one indicating that additional information is desired in relation to the events/groups provided on the display at the point in time of the input. However, normal event providers would then provide the second parameters (additional or alternative information) only for one event/group, whereby only part of the display may be used or whereby information relating to other events/groups, which may be equally interesting to the user, will not be provided.

According to this aspect of the invention, the second parameter(s) is/are provided for at least two neighbouring groups of events. Then, additional information is provided to the user. Naturally, it may be desired that the second information or parameters is/are provided for all groups of events, whereby maneuvering

Naturally, all types of events, groups of events, parameters and the like may be those discussed further above.

The user interface may be any type of user interface. Normally, the user interface comprises both a display/monitor/sound emitter for providing information to the user as well as means for the user to input information or selections. These input means may be tactile, via buttons, a touch screen, a joystick, a rotatable wheel or the like, or be adapted to receive and interpret audio commands. Alternatively or in addition, the user may input information by moving the player in relation to him/herself or the surroundings, when movement detection means are provided.

Normally, the providing on the user interface of information relating to a group of events will be a list of parameters/identifiers (such as titles of music tracks) which the user may choose from. However, any other manner of providing the information, such as playing a bit of each track or displaying a bit of a video sequence, providing thumbnails of pictures, illustrating bitmaps identifying the track/event or the like may also be used.

Providing the system as an eBook feature, titles and covers are presented and playing may be interpreted e.g. to disclose the abstract of the book.

While providing the information relating to the events of the group to the user, the user may then choose to have the events of the group provided in a sequential manner.

Preferably, the step of providing the one or more second parameters of the events of the at least two groups comprises providing, with each group of events, the second parameter(s) in a predetermined order. This ordering may be chosen by the user on the basis of e.g. one or more of the parameters of the events.

In one embodiment, the step of providing the one or more first parameter(s) and/or the one or more second parameter(s) comprises providing, for each group, a text and/or a graphical image and/or an audio-video media sequence identifying the group of events.

Preferably, the method further comprises the step of providing the events of a first of the at least two groups of events on an event provider, subsequent to the providing of the last event of the first group of events, the events of the next of the at least two groups of events (In the order) being provided. Consequently, it is clear that upon e.g. providing a predetermined input, the media player will require no other actions by the user before starting to provide the events in the sequential manner. This predetermined input may be the activation of a predetermined button or other touch sensitive element or part of a media player, or any other specific instruction which the media player may interpret.

In addition, it may be desirable that the step of selecting the first of the at least two groups of events automatically addresses the first group in predetermined order, when the last event in the last group, in the order, has been provided.

Naturally, the user may scroll the information provided so that the first and optionally the second parameter(s) is provided for sequential groups of events. Then, it may be desired that when reaching the end of the groups of events, further navigation in that direction will make the navigation re-start at the opposite end of the order of the groups of events.

Finally, naturally, the user may select a single event, a group of events or more events/groups for providing in a particular order, e.g., by a media provider.

An eighth aspect of the invention relates to an apparatus for providing events to be provided to a user on an event provider, the method comprising:
means for storing or providing a plurality of groups of events, each group of events comprising a number of events and having, common to all events thereof, one or more first parameters, each event having one or more second parameters,
a display,
means for controlling the display to provide, in a predetermined order, one or more of the first parameters of a plurality of groups of events,
means for receiving an input from the user,
the controlling means being adapted to, subsequently to determining the input, control the display to provide one or more of the second parameters of one or more events of at least two groups of events positioned adjacently in the predetermined order.

As mentioned above, the second parameter(s) may be provided (even though not provided on the display simultaneously) by the display when scrolling through the order of the groups, and the controlling means may automatically provide an opposite end of the ordering, once one end has been reached.

As mentioned the user interface may be of any desired kind but normally will comprise a display/monitor and means for the user to input instructions to the media player in order to select groups and/or events to be provided and/or navigate in a menu structure of the media player. In particular cases, the media player may be adapted to output audio information relating to e.g. events which may be provided as well as receive information either as sound or as movement of the media player or part thereof.

In a preferred embodiment filter attributes are predefined for: genre, artist, album, year and composer. This is most applicable for Audio/Video related media information.

In a preferred embodiment sorting rules are defined. Sorting rules that determines the order of processing to take place according to the user specified filter criteria:
If entry is ‘genre’ then it implies ‘artist’ followed by ‘album’.
If entry is ‘year’ then it implies ‘artist’ followed by ‘album’.
If entry is ‘composer’ then it implies ‘album’.

In another embodiment filter attributes are predefined for: title, topic, genre, author, year and publisher. This is most applicable for books/news/magazines related media information.

In the preferred embodiment, filter attributes may be redefined and new ones may be added by the user.

In the preferred embodiment, sorting rules may be defined according to the rules given in the Boolean algebra.

The means for allowing the user to select between the events of the group may form part of the user interface and may, as described above, be of any desired type, such as touch buttons touch pads, rotatable wheels, or the like.

During scrolling through the list, a differentiated audible signal may be provided to the user. This audible signal a being a content and/or context dependent sound feed back to the user.

Content normally is related to the type of information that is being displayed. Context may be related to the actual position within the search list.

Examples may be a user initiated scroll with the sound feedback having an increasing frequency, the faster the scroll is, and the closer the search is to the target information the lower the frequency of sound signal.

Naturally, when providing the information relating to the events of the group, the user interface may not be adapted to actually represent all groups and all events of the group simultaneously. This may be as the situation in which a title of each track of an album are represented on a small display, where scrolling is required in order to see all titles. Nevertheless, the Information relating to all tracks/events may be provided in the same view.

At the same time, the user may input an Instruction to have the media player provide the events of the displayed group in a sequential manner in an order as first sequential or sorted in any user requested order.

In general, it may be desired that an event provider provides audible signal to the user, when e.g. scrolling through a list of events/groups. This audible signal being a content and/or context dependent sound feed back to the user.

Also, in general, it may be highly desirable that the providing or presenting of information relating to events or groups of events is organized as a list of graphical objects, and the list outlined in a spiral form or a circular form (or square, triangular, oval or other shapes), in that this may be more easily controlled by the user.

Naturally, the above aspects and embodiments thereof may be combined or mixed in any manner in that even further advantages will thereby be obtained.

In the following, preferred embodiments of the invention will be described with reference to the drawing, wherein:

FIG. 1 illustrates a manner of selecting events to be provided on an event player,

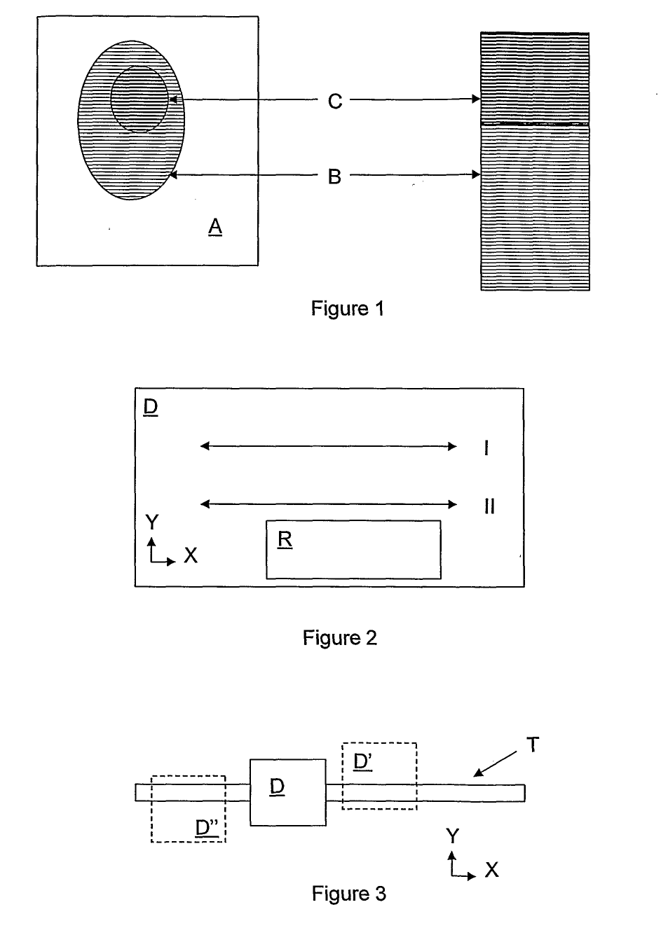

FIG. 2 illustrates a first embodiment of an apparatus for selecting an event or a group of events, such as for providing on an event player,

FIG. 3 illustrates an alternative to the embodiment of FIG. 2,

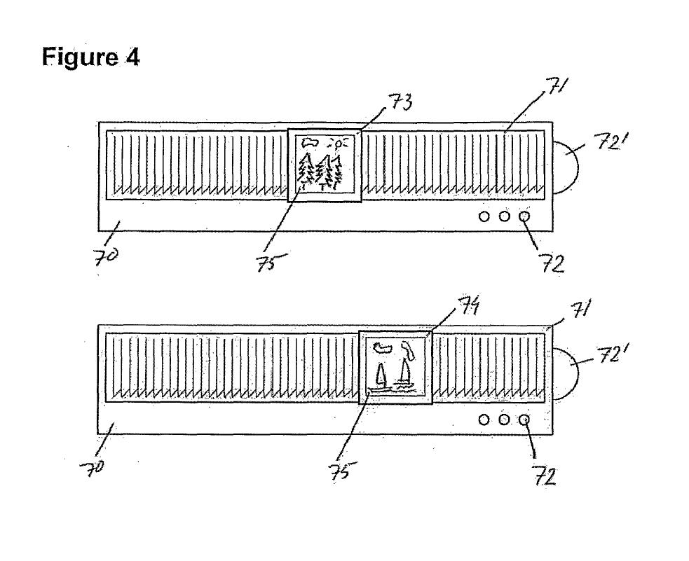

FIG. 4 illustrates an alternative to the embodiments of FIGS. 2 and 3,

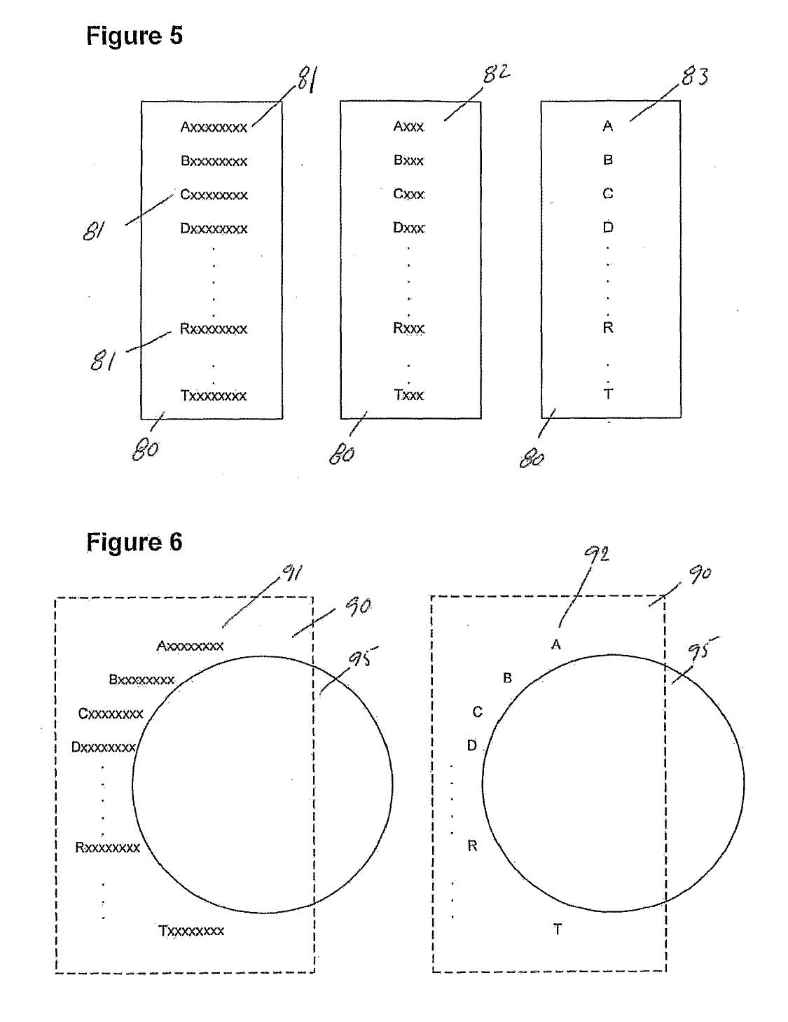

FIGS. 5 and 6 illustrate a manner of manoeuvring in pieces of information,

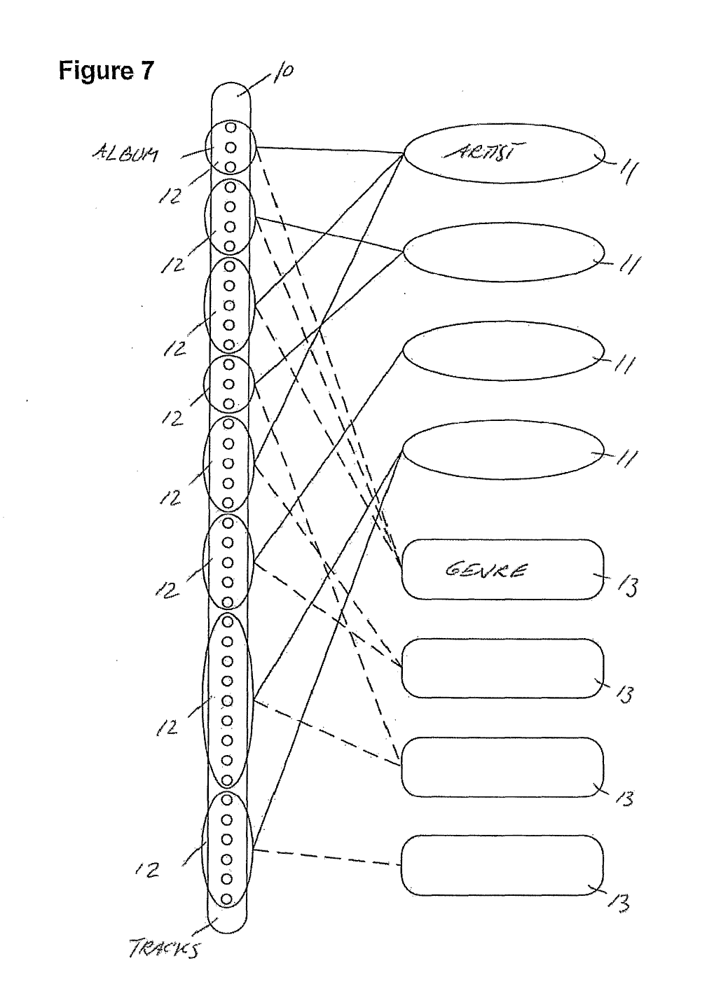

FIGS. 7-11 illustrate a manner of applying a sequential play list in a media player according to the invention, and

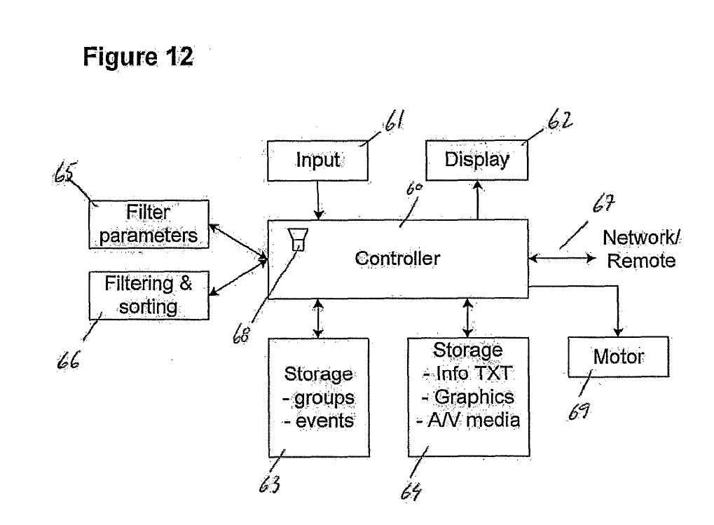

FIG. 12 illustrates typical elements for use in the invention.

In FIG. 1, a group of events is illustrated as a square A. Each event or each subgroup of events therein is categorized by one or more parameters. Such parameters may, for music or audio in general, such categories may be: author, artist (e.g. Justin Timberlake), group (e.g. the Jackson Five), composer (e.g. Andrew Lloyd Webber), label (eg. EMI, mute record, motor music, . . . ), genre (e.g. pop, rock, beat, classic, jazz, . . . ), beats-per-minute, name (of any person related to the music), title (such as of the track or album), producer (e.g. Quincy Jones), date/year of production/issuance/birth (of the track, album, artist, composer or any other person related to the music), theme (such as musical, film track), or any other characteristics of the audio.

Naturally, any item within the group may be a track or an album or other sub-group of events.

For movies, plays or other video, the categories may be the same, especially for music videos and musicals, but also other categories may be relevant, such as actor(s) (such as Tom Hanks), genre (family, action, thriller . . . ), director (such as George Lucas), or the like.

For literature, books, articles or the like, other parameters may be relevant, such as publisher, and for even other events, particular parameters will be relevant for these.

In this group A of events, a search is performed on the basis of one or more of the categories. This search may be a Boolean search (a search for a category or events not being in the category, or a more complex search relating to events in or not within one or more categories). The result of this first search is the hatched group B.

Within the group B, a further search is made on the basis of other categories or another combination of categories, and this second search results in a subgroup C of the events in the group B. Thus, the group B comprises the combination of the two hatched areas.

Having now performed two searches, a list of events is made for introduction to or providing on a media player, such as a stereo, a N, a display, audio equipment or the like, and in a predetermined order, where the events of the subgroup C are provided before the remaining events of the group B.

Consequently, all events of the group B are actually selected, but the second search identifies the events provided firstly within this group.

Thus, for example, when using this method of selecting events for selecting events to be provided on a player, the events of group C will firstly be played, where after the player will continue with the remaining events of group B.

In FIG. 1, this is illustrated as the order of providing of the events in the list at the right of the figure will be from the top thereof.

FIG. 2 illustrates a user interface, which may be a monitor or display D, defined by an X-Y coordinate system, on which two axes, I and II are defined along the X direction.

A user is able to determine or select a position on this display D on one of the axes I or II, and a system is provided which correlates the determined position with an event, where after information relating to the event is provided on the display D, such as within the area R.

Naturally, it is not required that all positions relating to all events be positioned within the boundaries of the display D, or even that any of these positions are.

The backing system (see further below) will have access to the events, such as from a CD library or from other sources, such as RAM, ROM, PROM, EPROM, hard disc, tape storage, optical storage, floppy disc, external services, such as the WWW, or the like. The events will be ordered according to a category or a combination of categories, and this order will define the individual event's position along the axis I.

Thus, when the user determines or selects a position, the pertaining event will be identified by the system, and information relating to that event will be displayed on the display D.

The information provided will depend on the type of event. For tracks/albums, the information may be all of or a selection of the categories thereof or the cover thereof as may be seen on e.g. a CD with the album/track. For movies/plays, the same may apply, and for books/articles, the cover or the actual text may be provided.

Of course, if video of some type is selected, the full area of the display D may be used for providing the video to the user, or another display or monitor may be used for that purpose.

Naturally, the user may scroll between positions, whereby the information illustrated will relate to a number of sequential events (In the order defined along the axis I) may be provided.

If the selection of the position is performed by the display D being a touch sensitive display, and where all positions of all events are within the boundaries of the display D, the user may simply touch the display D at a position at which the user contemplates that the desired event is represented. If this is not the correct position/event, the user may select another position or simply run e.g. a finger in the desired direction along the axis I in order to find the desired event or see which events are available. This running of e.g. a finger along the axis I will provide information from the events in a sequential order according to the order in which the positions have been determined.

Alternatively to the use of the stationary area R for providing the information relating to the event/group at the Identified position, the information may be provided on an area of the display D corresponding or correlated to the position identified. In this manner, different positions on the display will be used for providing information relating to different events/groups. In fact, moving the finger along the axis I may then provide the information at the same positions and thereby follow the finger.

In the preferred embodiment, it is desired to actually have the same events ordered after two different systems. Thus, one ordering may be alphabetically after the name of the artist/group, and another ordering may be after genre. The first ordering may be that of the axis I.

In order to facilitate that a user may actually also search in the events in accordance with the second order, a second axis II is defined in parallel to the axis I. Thus, the user may perform the above searching/selection in the first ordering along the axis I and in the second ordering along the axis II.

Naturally, the axes I and II need not be parallel.

Then, the events will be positioned differently along the two orderings. Thus, even though “Anastacia” is before “Monserrat Caballe” in an alphabetical order of the name of the artist, “Opera” may be positioned before “Pop” in an ordering of genres.

The position of any selected event on both axes I and II may be illustrated to help the user navigate in this user interface. This illustration may be by providing the information relating to the event/group at that position.

Having selected a position, the information provided relating to the pertaining event or group of events may enable the user to perform additional selections, such as selecting a track from a selected album.

In addition, the information provided may Inform the user of interesting information related to the event, such as that relating to the different categories.

Finally, the user may choose to have the event provided (music played, movie provided on a TV, a book displayed or printed, or the like). Actually, this may be performed automatically after having selected the position along one of the axes I or II.

In the embodiment of FIG. 2, the two axes I and II may be separated by being two different parts of the display D. Naturally, a number of other manners exist of selecting on which axis (which ordering is desired) the actual position is meant to be on. FIG. 3 illustrates a quite different embodiment, in which the display D is smaller but is now displaceable along a track T.

The actual position of the display D along the track T defines the position, and the information relating to the event is provided on the display D.

The user may cause a translation of the display D along the track T in a number of manners, such as a manual translation, or the use of remote control or other controls by which the display D is automatically translated either in a desired direction or even to a desired position or event.

While being translated, the display D will provide the information relating to the events, the position of which the display is translated past, so that the user may use this to search for a particular event or a particular category (album, artist, or the like).

In order to facilitate the shifting between the different manners of ordering the events, the display D may be shifted upwards (a position is illustrated by the display D'), or downwards (a position is illustrated by the display D″), such as to illustrate to the user which ordering is active.

Naturally, the user may customize the orderings desired for the three vertical positions provided in the present embodiment.

Shifting from one axis or ordering to the next (shifting the display D upwards or downwards) will cause the display D to be translated to the position of the presently selected event in the next ordering. Thus, if the user likes a presently selected event, he/she may select an ordering related to the genre or artist in order to easily identify other events of the same artist or genre. Shifting to the other ordering, the display D will then automatically move to the position of the actual event/group in the new ordering.

If the display D is positioned between two positions of two events, it may be decided that the full information of the event being the closest to the position of the display D is displayed. Alternatively, a part of the information of both events may be provided. In one embodiment, where the information is an image of a cover of each event, it may look as if the covers are positioned side by side, and the sliding of the display D will slide the row of covers by the display D, so that when positioned between the positions of two events, parts of the covers thereof is displayed. This effect may also be used for other types of information provided for the individual events.

Naturally, the information provided on the display D may Inform the user about the event, but it may also provide the user with a choice between different operations which have to do with the event or group of events. One such operation is the choice between different tracks on the album, the position of which the display D is at. Choosing a track may transfer the track to a player which then plays the track. Other choices may be to include the track on a playlist, removal or copying of the track, and all other operations normally performed on tracks, albums or other events.

FIG. 4 illustrates an alternative to the embodiments of FIGS. 2 and 3, in that a display 70, which again may be e.g. a CRT, LED, OLED, and/or LCD based display, The display 70 may be a touch screen and/or may have buttons 72 for the user to use.

In addition, a slider 75 is provided. This slider 75 merely defines a position and may e.g. be shaped like a magnifying glass, whereby the sliding of the slider 75 horizontally in relation to the display 70 will define the relevant position.

While the slider 75 is sliding, the display 70 will provide the Information relating to the event/group at each position visited by the slider, and at the actual position of the slider 75, so as to provide this information within an area, such as a window, defined by the slider 75. Two positions 73 and 74 are illustrated of the slider, and it is seen that the information, here different images, of two different events/groups is provided by the display 70 at the actual positions of the slider 75.

At 71, it is seen that the events/groups not assigned the present position are merely represented by a vertical line. This is not a requirement but merely illustrates to the user that additional events/groups are available.

The buttons 72 may be used for controlling the sliding of the slider 75 and any subsequent selection of the event/group at the final position or other operation of the system.

As an alternative or addition to the buttons 72, a rotatable wheel or circular touch pad 72′ is illustrated which may just as well be used for controlling the sliding of the slider 75 and the selection of a position. A further alternative is one wherein the slider 75 may be manually translated by the user.

FIGS. 5 and 6 illustrate a novel manner of manoeuvring in a number of pieces of Information. In the following, the aspect will be described with reference to searching in texts, such as track titles, but the same manner may be used in searching in images or the like.

It has been noted that when swiftly looking through texts, the user tends to focus only on a small number of characters, and the number of characters which the user focuses on will decrease with the speed of scrolling.

Thus, a user interface is provided comprising a display 80 for providing the texts and means for the user to use for selecting or inputting a direction of scrolling and a speed of scrolling. Searching through the texts will have the texts scroll over the display 80 in the desired direction and at the desired speed.

The direction and speed may be controlled by the user using any type of controlling means, such as the buttons 72, the wheel/touch pad 72′, a computer mouse, where the display 80 is a touch screen, or any other means.

The speed of scrolling will denote the speed at which a text moves over the display 80, the rate of replacement of the text at a position on the display 80, the period of time during which a text is provided at the same position on the display 80, or any other manner of quantifying the scrolling.

Normally, the texts to be provided are ordered in a desired manner, such as an alphabetical manner, or according to any of the parameters described further above.

In FIG. 5, the texts are illustrated as 81 with relatively many characters represented on the display 80, fewer characters represented at 82, and at 83, the texts are represented merely by a single character, such as the first character of the illustrated texts.

The number of characters represented for each text is determined on the basis of the speed of the scrolling. Scrolling slowly will represent the most characters of the texts (81), such as the whole text. This may be used for identifying a desired text, where the user knows that it is nearby. Scrolling faster will bring about a representation of fewer characters (82) in that more characters may confuse the user, and scrolling fast may bring about the representation of only a single character (83) In that this is the easiest for the user to control.

Thus, the faster the scrolling, the fewer characters is represented.

For other types of information, such as images, the same method may be used, where the reduction in information amount may be a reduction in the size of the image (where the full image is reduced in size), or wherein less relevant parts of the images are removed. Also, dominant colours of the images may be derived and represented, when fast scrolling is performed.

FIG. 6 illustrates another type of display 90 using the same manner of manoeuvring. In this embodiment, the texts 91, 92 provided are provided along a semi-circular part of a display 90, which may be desirable in certain situations. One situation may be one in which a rotatable wheel or a circular touch pad 95 is provided for the user to manipulate in order to define the direction of scrolling (rotation of the wheel 95) and the speed (rotational speed). This wheel/pad 95 may be engaged from an upper side (extending in the plane of the figure) or on the circular periphery, extending out of the plane of the figure.

FIG. 7 displays a picture of a plurality of events/tracks (10) that's available from a media source of information. An event in this context may e.g. be a media file or a link to a media file. The predefined or user defined organisation of events are based on the given attributes like author, artist (11), album (12), genre (13) or the like.

The same event (e.g. a media file) may apply in one or more groups at the same time.

The same information mapping scheme is applicable for books, articles, and the like.

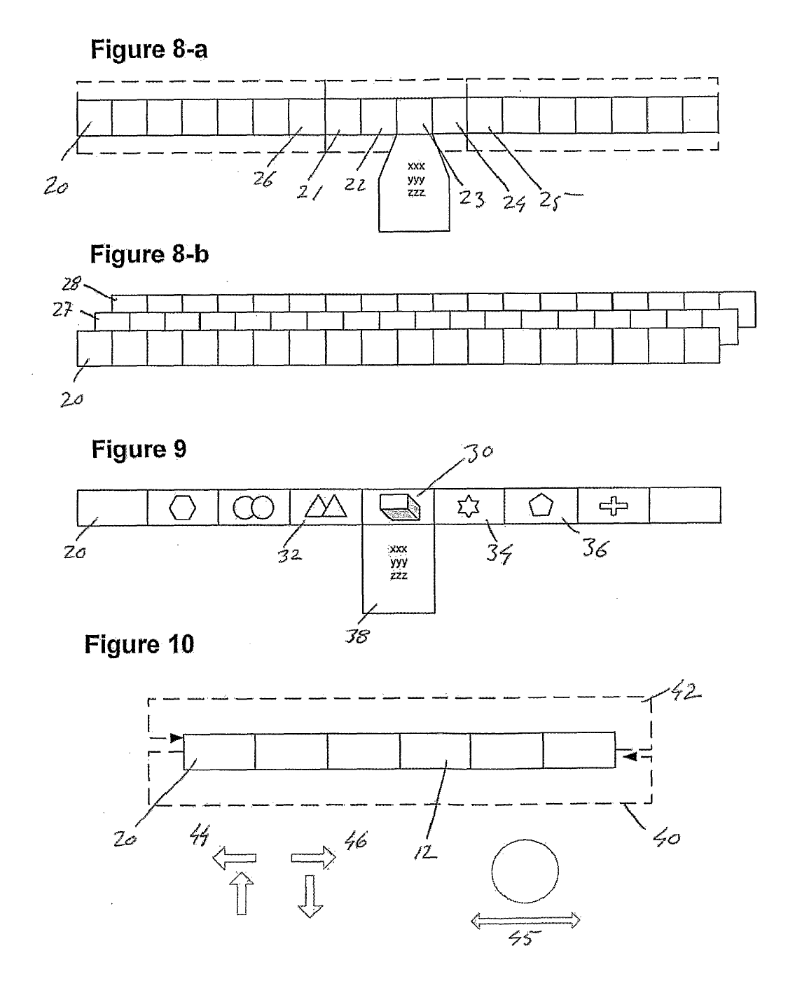

FIG. 8 displays a picture of the list (20) of sequential groups/events that's available from a media source of information after user given filter criteria has been applied.

More play lists may exist in parallel, each one (27, 28) reflecting a set of applied filter parameters.

A list may contain:
one or more groups of events fulfilling the primary filter key(s),
one or more groups of events fulfilling one or more secondary filter keys.

As an example, the primary filter key may be: ‘author name beginning with c’, and the list may contain:
A group of events for each collection of events per author which name is beginning with ‘c’, e.g. Chopin (21).
A group of events for each collection of events per author which name is beginning with the predecessor to ‘c’, i.e. the character ‘b’, e.g. Beethoven; this is an adjacent group above the providing group (26).
A group of events for each collection of events per author which name is beginning with the successor to ‘c’, i.e. the character ‘d’, e.g. Dvorak; this is an adjacent group below the providing group (25).
If there are more than one group fulfilling the primary search filter key, e.g. the ‘c’ criteria, the relevant groups are ordered as a second level criteria like ‘ca’, ‘cb’, ‘cc’ etc. (21,22,23,24).

FIG. 9 displays a picture of the information provided with the sequential list (20) of groups of events that's available from a media source of information after user given filter criteria has been applied.

The figure also illustrates the concept of: provided group (30), adjacent below provided group (34), adjacent above provided group (32), the group information and the event information (38).

Information on the list may contain:
Group information (30,32,34,36), as text, as graphical image or as A/V media scene; an example is graphical display of a CD cover, or a graphical display of an identifier of the group holding a set of CD covers.
Event/content information (38), as text, as graphical image or as A/V media scene; an example is the textual display of titles from a CD cover. This information may e.g. displayed as pop-down window when the group is accessed.

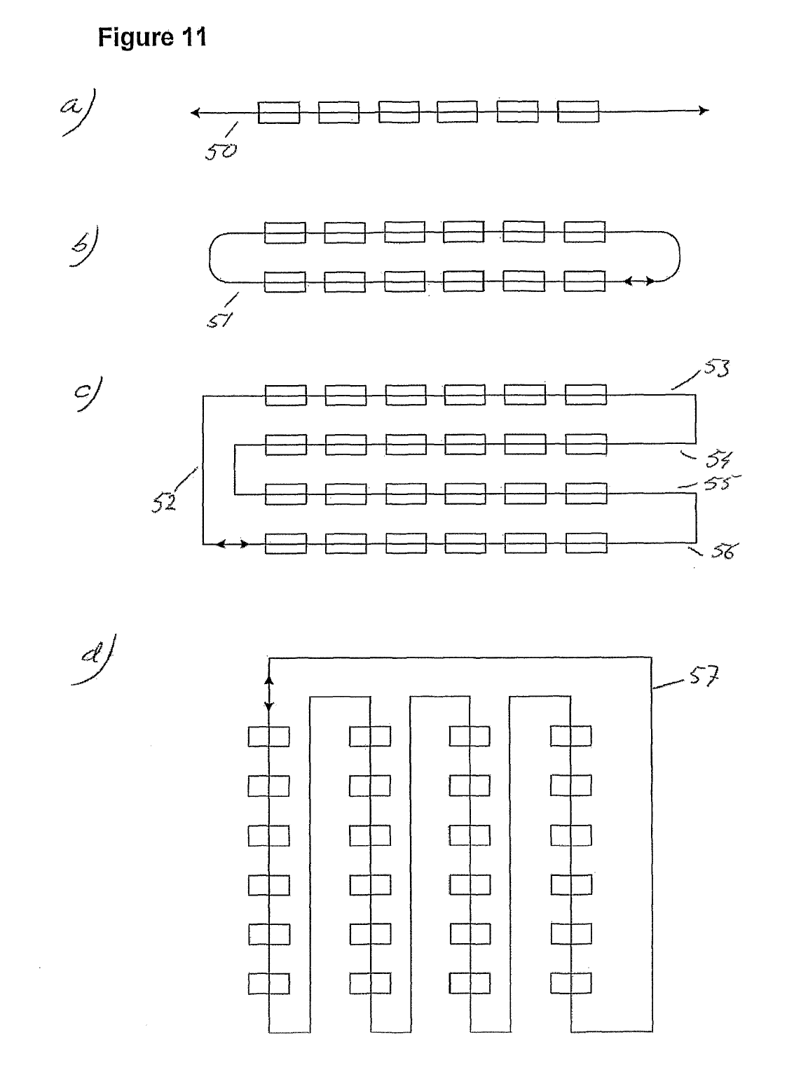

FIG. 10 displays a picture of the list (20) of sequential groups/events that's available from a media source of information after user given filter criteria has been applied.

The user may scroll through the list of groups/event(s) as desired by means of navigation buttons like a wheel like type (45) or whatever navigation key type (44, 46).

A kind of cyclic navigation is supported, as a virtual link is established from the ‘last’ group to the ‘first’ group to support automatic or manual the navigation function ‘next group/event’ (42) or the navigation function ‘previous group/event’ (40). This is to provide the addressing of the adjacent groups/events.

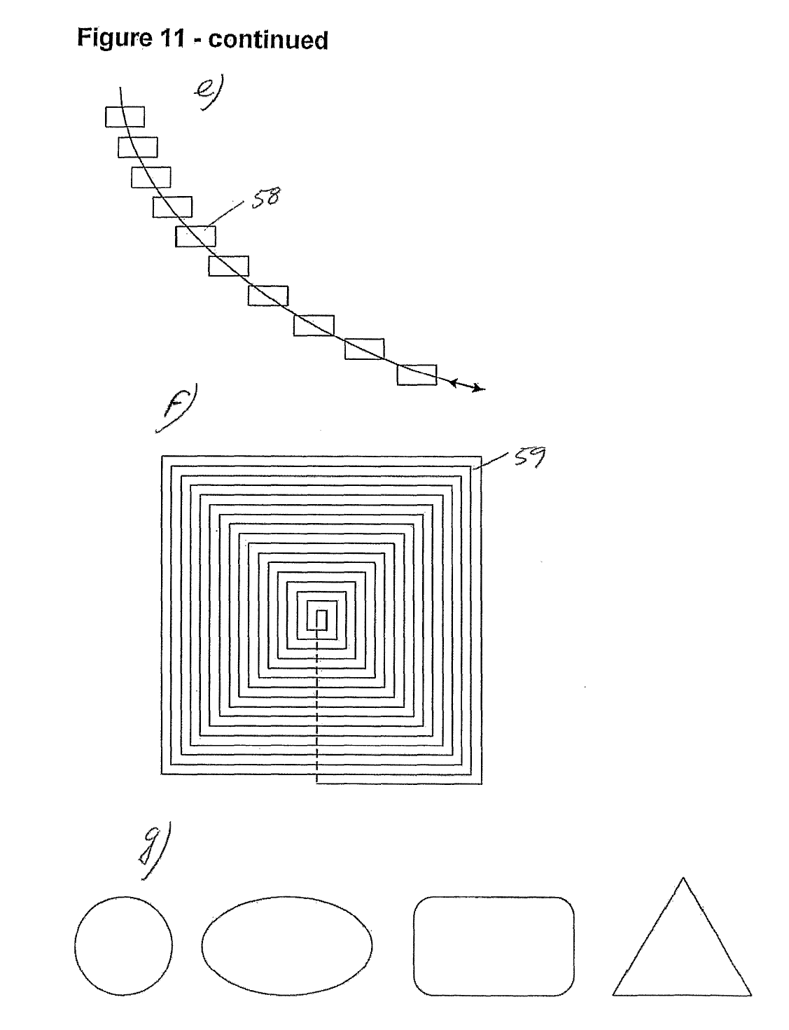

FIG. 11 illustrates different alternatives in the presentation of the dynamic play list:
The sequential list may be organized in a horizontal outline (50). Groups are linked into a list fixed in length.
The sequential list may be organized in a circular/rounded rectangle outline (51). Groups are linked into an endless list.
The sequential list may be organized in a combined horizontal and vertical outline (52).
As an option the complete list may be a combination of individual lists (53,54,55,56) linked together into an endless list.
The sequential list may be organized in a combined vertical and horizontal outline (57).
As an option the complete list may be a combination of individual lists linked together into an endless list.
The sequential list may be organized in a combined vertical and horizontal outline and aligned according to any geometrical shape (circle, elliptical, square, rectangle, rounded rectangle, and polygon.
The sequential list may be organized in a combined vertical and horizontal outline and an aligned curve part (58) according to the geometrical shape circle or elliptical.
The sequential list may be organized in a combined vertical and horizontal outline and an aligned curve part (59) according to the geometrical shape of a spiral (circled, elliptical, triangle or squared; (FIG. 11-g).

FIG. 12 displays a picture of the primary controller means of the media player.

The main processor (60) controls processing of the user interface input means (61) the display means (62) and storage and access to/from memorized data like attributes used for filtering (65), groups and events archive (63), information text, information graphics and information A/V media files (64). The generating of the list is supported by the filtering, the sorting and presentation function (66). Alternatively or supplemental media source of information may be accessed from a network (LAN, WAN, Internet, remote wireless terminal) (67), this includes access to podcast data. A sound generator (68) to provide audible information may be integrated into the controller (60).

In addition, an input/output 69 is provided for controlling a motor for moving a display or another movable device (see FIGS. 3 and 4).

The user may wish strictly to select or search between only parts of the events/music pieces on the player. This is facilitated in a number of manners: the user can select between a grouping/filtering as to “artist”, “album”, or “genre”. Each of these groups normally represents only a part of the tracks stored on the media player.

Selecting “artist” results in the user interface presenting the user with a list of the artists having authored tracks stored on the media player. The user thereafter will select an artist, whereby only the group of events authored by that artist is provided, whereby the user interface will inform the user of the tracks authored by the selected artist.

Selecting “album” will result in the user interface presenting the user with a list of the tracks, stored on the media player, and being from the selected album. Normally, these tracks will have a predetermined order determined by the order of the tracks on the actual album.

Selecting “genre” will result in the user interface presenting the user with a list of different genres, such as pop, rock, folk. Having selected a genre, the user interface will present the user with a number of tracks, stored on the media player, which fall under the selected genre.

In addition to this navigation method, the user may also be able to choose that one or more tracks are repeatedly provided.

Thus, when the tracks to be provided are selected either by selecting the actual track, the Album, all tracks of which are to be provided, the artist, all available tracks of which are to be provided, or a play list, all tracks of which are to be provided, the media player may either play all tracks a single time (repeat off) or repeat the track/tracks indefinitely (repeat on).

If, however, the user has decided to shuffle a filtered group of tracks (selected by artist, album, genre or play list, e.g.), the media player may be adapted to always play the shuffled tracks indefinitely, i.e. Independently of whether the user has selected the “repeat” function of the media player.

1-40. (canceled)

41. A method of operating an event provider, the method comprising:
providing a plurality of audio, image or video events or groups of events adapted to be provided on the event provider, each event/group having a number of parameters assigned thereto,
selecting, using a first search criterion on the basis of one or more of the parameters, a first group of the plurality of events/groups falling within the first search criterion,
selecting, using a second search criterion on the basis of one or more of the parameters, a second group of events/groups from the first group of events/groups falling within the second search criterion,
providing a list of events/groups to be provided on the event provider, the list comprising the events/groups of the second group of events/groups and the remaining events/groups of the first group of events/groups in a predetermined order.

42. A method according to claim 41, wherein the predetermined order is the events/groups of the second group of events/groups being provided before the remaining events/groups of the first group of events/groups.

43. A method according to claim 41, further comprising the step of the event provider sequentially providing the events/groups in the order of the list.

44. An event provider for providing, to a user, audio, image or video events or groups of such events from a list of events/groups, the provider comprising:
means for holding or accessing a plurality of events/groups adapted to be provided on the event provider, each event/group having a number of parameters assigned thereto,
means for providing one or more events/groups to the user,
means for allowing a user to select, using a first search criterion on the basis of one or more of the parameters, a first group of the plurality of events/groups falling within the first search criterion,
means for allowing the user to select, using a second search criterion on the basis of one or more of the parameters, a second group of the first group of events/groups falling within the second search criterion,
means for controlling the providing means to provide the events/groups of the second group of events/groups and the remaining events/groups of the first group of events/groups in a predetermined order.

45. An event provider according to claim 44, wherein the controlling means is adapted to provide, to the providing means, the events/groups of the second group before the remaining events/groups of the first group of events/groups.

46. An event provider according to claim 44, the provider being adapted to provide, sequentially, the events/groups in the order of the list.
